(19) United States
(12) Patent Application Publication
(10) Pub. No.: US 2024/0226948 A9
(43) Pub. Date: Jul. 11, 2024

(54) SYSTEMS AND METHODS OF FORMING ROOFING SHINGLES WITH APPLICATION OF A FIBERIZED ADHESIVE

(71) Applicant: BMIC LLC, Dallas, TX (US)

(72) Inventor: James A. Svec, Kearny, NJ (US)

(21) Appl. No.: 18/382,787

(22) Filed: Oct. 23, 2023

Related U.S. Application Data
(60) Provisional application No. 63/419,131, filed on Oct. 25, 2022.

(51) Int. Cl. B05C 5/02; C09J 5/00; C09J 9/00; E04D 1/26; E04D 1/28

(52) U.S. Cl. CPC B05C 5/025; C09J 5/00; C09J 9/00; E04D 1/26; E04D 1/28

(57) ABSTRACT

Systems and methods of forming roofing shingles having selected patterns of an adhesive material applied thereto include a conveying system along which a roofing substrate material is conveyed past an adhesive applicator having a nozzle configured to apply a fiberized adhesive to a surface of the roofing substrate material, the fiberized adhesive adapted to attach a layer of the roofing substrate material to an additional layer for forming the roofing shingles. A drive system is coupled to the nozzle and is configured to move the nozzle across the roofing substrate material as the roofing substrate material is moved along a processing path for selectively applying a pattern of the fiberized adhesive across the roofing substrate material.

### REFERENCE TO RELATED APPLICATION

The present Patent application claims the benefit of U.S. Provisional Patent Application No. 63/419,131, filed Oct. 25, 2022.

### INCORPORATION BY REFERENCE

The disclosure of the U.S. Provisional Patent Application No. 63/419,131, filed Oct. 25, 2022, is specifically incorporated by reference herein as if set forth in its entirety.

### TECHNICAL FIELD

This disclosure relates generally to roofing shingles and to systems and methods for the manufacture of roofing shingles; and in particular, to systems and methods for the manufacture of roofing shingles including application of a fiberized adhesive to form roofing shingles.

### BACKGROUND

Laminated roofing shingles can have an adhesive applied between a backer and an upper layer of shingle material for adhesively attaching the upper layer to the backer. It can be seen that needs exist for roofing shingles having an enhanced bond between the backer and upper layer of such roofing shingles without having to apply additional adhesive between the backer and upper layer, and for systems and methods of manufacturing such roofing shingles. The present disclosure addresses these and other related and unrelated issues.

### SUMMARY

Briefly described, according to aspects of the present disclosure, roofing shingles and systems and methods for manufacturing roofing shingles are provided. In embodiments, systems and methods for forming roofing shingles having an adhesive material applied between a first layer and a second layer thereof are provided. In some embodiments, the adhesive material can be applied as a fiberized adhesive.

In some embodiments, the system can comprise a conveying system along which a roofing substrate material is conveyed in a first direction through an adhesive station, which can include an adhesive applicator having a nozzle configured to apply an adhesive material along a surface of the roofing substrate material, for example, at areas corresponding to a common bond area between layers of the roofing substrate material forming the resultant roofing shingles. In some embodiments, the adhesive material can comprise a fiberized adhesive adapted to attach a first layer of the roofing substrate material to an additional, second layer of the roofing substrate material for forming the roofing shingles. In embodiments, the adhesive applicator further can include a drive system that is coupled to the nozzle and configured to move the nozzle in a second direction across the roofing substrate material as the roofing substrate material is moved in the first direction along a processing path and through the adhesive station. In embodiments, the nozzle is moved in the second direction back and forth across the roofing substrate material, which movement can be varied for selectively applying a selected pattern of the fiberized adhesive to a surface of the roofing substrate material.

In some embodiments, applying the fiberized adhesive can comprise moving the nozzle in an eccentric motion in the second direction across the substrate so as to apply the fiberized adhesive to the roofing substrate material in a substantially helical or circular pattern across the surface of the roofing substrate material. In embodiments, applying the fiberized adhesive can comprise applying a selected pattern of the fiberized adhesive, for example, a pattern having an increased width across the roofing substate material, and/or a flatter pattern of the fiberized adhesive, versus applying larger beads of adhesive to provide increased bonding of the layers. In some embodiments, the fiberized adhesive can be applied in lines, strips, dots, or beads, or combinations thereof, that, in embodiments, can have an elongated, flattened, straight, helical, curved or substantially curved configuration, or combinations thereof, and, in some embodiments, can have gaps defined therebetween; while in further embodiments, varying thicknesses or densities of the fiberized adhesive can be applied at selected locations along the surface of the roofing substrate material. In some embodiments, the fiberized adhesive can be formed in patterns having intermittent thickness and/or areas of fiberized adhesive with varying size gaps therebetween.

In embodiments, the drive system can comprise an eccentric bearing mechanism coupled to the nozzle and comprising a first drive gear, an eccentric bearing positioned in engagement with the first drive gear, a second drive gear coupled to the first drive gear by a drive belt, chain, or other coupling, and a motor connected to the second drive gear and configured to rotate the second drive gear. In embodiments, in operation of the drive system, the motor can be controlled to control rotation of the second drive gear, which rotation of the second drive gear is translated to the first drive gear by the drive belt, chain, or other coupling, causing the first drive gear to rotate, and in turn, causing rotation of the eccentric bearing. In some embodiments, as the eccentric bearing is rotated, the nozzle is moved across the roofing substrate material in an eccentric motion to apply a selected pattern, e.g., a substantially helical or circular pattern, of the fiberized adhesive to the surface of the roofing substrate material.

Alternatively, in embodiments, the drive system can comprise a crank driven by a motor and coupled to a support along which the nozzle is mounted; wherein as the crank rotates, the nozzle is moved across the roofing substrate material to apply the fiberized adhesive in the selected pattern. For example, in embodiments, the fiberized adhesive can be applied as a substantially continuous spray of adhesive material, and as the eccentric bearing or the crank rotate, the movement of the nozzle can be varied such that the fiberized adhesive can be applied in a selected pattern, including applying the fiberized adhesive intermittently to the surface of the roofing substrate material. In embodiments, the patterns of fiberized adhesive applied to the roofing material substrate further can be varied or adjusted by controlling the rate of rotation of the eccentric bearing or crank, so as to control a rate and extent of the movement of the nozzle across the roofing substate material, and/or by controlling a rate of movement of the roofing substrate material through the adhesive station.

According to aspects of the present disclosure, a method is disclosed, the method comprising: conveying a roofing substrate material along a processing path in a first direction; as the roofing substrate material is moved along the processing path, moving the roofing substrate material past an adhesive applicator; wherein, in embodiments, the adhesive applicator comprises a nozzle configured to apply an adhesive material to a surface of the roofing substrate material and a drive system linked to the nozzle and configured to move the nozzle in a second direction with respect to the processing path; moving the nozzle in the second direction across the roofing substrate material as the roofing substrate material is moved along the processing path in the first direction; and applying the adhesive material to the surface of the roofing substrate material with the adhesive applicator; wherein the adhesive is applied to the surface of the roofing substrate material in a substantially straight pattern, a substantially helical or circular pattern or a combination thereof.

In embodiments of the method, moving the nozzle in a second direction comprises rotating the nozzle of the adhesive applicator in an eccentric motion back and forth across the surface of the roofing substrate material.

In some embodiments, the drive system comprises an eccentric drive mechanism coupled to the nozzle, the eccentric drive mechanism comprising a first drive gear, an eccentric bearing positioned in engagement with the first drive gear, and a motor coupled to the first gear and configured to rotate the first drive gear; wherein rotation of the first drive gear causes rotation of the eccentric bearing; and wherein moving the nozzle in the second direction across the roofing substrate material comprises rotating the nozzle across the surface of the roofing substrate material in an eccentric motion in response to rotation of the eccentric bearing.

In some embodiments, moving the nozzle in the second direction across the roofing substrate material comprises moving the nozzle in the second direction across the surface of the roofing substrate material along an initial path of travel at a first rate, and moving the nozzle along a return path of travel back across the surface of the roofing substrate material at a second rate; wherein the second rate is different from the first rate.

In embodiments, the drive system can comprise an eccentric drive mechanism coupled to the nozzle, the eccentric drive mechanism comprising a first drive gear, an eccentric bearing positioned in engagement with the first drive gear, and a motor coupled to the eccentric bearing and configured to rotate the eccentric bearing; wherein as the eccentric bearing is rotated, the nozzle is moved in the second direction across the roofing substrate material as the roofing substrate material is moved in the first direction; and wherein applying the substantially straight pattern, substantially helical or circular pattern, or a combination thereof, of the adhesive material to the surface of the roofing substrate material further comprises rotating the nozzle in an eccentric motion as the nozzle is moved in the second direction.

In embodiments of the method, applying the substantially helical or circular pattern of the fiberized adhesive to the surface of the roofing substrate material further comprises applying varying thicknesses or densities of the adhesive material at selected locations along the surface of the roofing substrate material.

In embodiments of the method, applying the substantially helical or circular pattern of the adhesive material to the surface of the roofing substrate material further comprises dispersing a fiberized adhesive in an intermittent pattern of curved dashes or beads of the fiberized adhesive.

In embodiments of the method, applying the substantially straight pattern, substantially helical or circular pattern, or a combination thereof of the adhesive material to the surface of the roofing substrate material comprises intermittently spraying a fiberized adhesive to the surface of the roofing substrate material; and wherein the fiberized adhesive comprises a self-seal adhesive.

In some embodiments, intermittently spraying the fiberized adhesive to the surface of the roofing substrate material can comprise varying an amount of the fiberized adhesive supplied to the nozzle; applying at least a first thickness or density of the fiberized adhesive at a first position to the surface of the roofing substrate material, and applying a second thickness or density of the fiberized adhesive at a second position to the surface of the roofing substrate material.

In embodiments of the method, applying the pattern of the adhesive material to the surface of the roofing substrate material can comprise applying a substantially continuous fiberized spray of the adhesive material to the surface of the roofing substrate material with the nozzle as the nozzle is moved in the second direction across the roofing substrate material, and controlling movement of the roofing substrate material in the first direction to form an intermittent pattern of the fiberized adhesive on the surface of the roofing substrate material.

In embodiments, the adhesive material comprises an asphalt adhesive.

In addition, in some embodiments of the method, the drive system can comprise a support having a first end portion along which the nozzle is mounted and a second end portion linked to a crank, and a motor coupled to the crank and configured to drive rotation of the crank; wherein moving the nozzle across the processing path comprises controlling rotation of the crank so as to move the support in a substantially linear motion to cause move the nozzle back and forth across the surface of the roofing substrate material.

In embodiments, the roofing substrate material comprises a first layer and a second layer; and wherein applying the adhesive material to the surface of the roofing substrate material comprises applying a fiberized spray of a self-seal adhesive to a surface of at least one of the first and second layers along an area corresponding to a nail zone of a finished roofing shingle.

In embodiments of the method, applying the adhesive material to the surface of the roofing substrate material comprises depositing at least a first thickness or density of the adhesive material at a first position on the surface of the roofing substrate material and a second thickness or density of the adhesive material at a second position on the surface of the roofing substrate material along an area corresponding to a common bond area of a finished roofing shingle.

In some embodiments, the adhesive material comprises a self-seal fiberized adhesive adapted to substantially seal about a nail head of one or more fasteners received through a nail zone of a finished roofing shingle.

In other embodiments, applying the selected pattern of the fiberized adhesive to the surface of the roofing substrate material can comprise depositing a plurality of lines, strips, beads, dots, or combinations thereof, of the fiberized adhesive along a common bond area between first and second layers of a finished roofing shingle.

In some additional embodiments, applying the adhesive material to the surface of the roofing substrate material can comprise depositing a plurality of lines, strips, beads, dots, or combinations thereof, of a fiberized adhesive along an area opposite an exposure portion of a finished roofing shingle adjacent a forward edge thereof.

According to other aspects of the disclosure, an apparatus comprises a conveying system configured to move a roofing substrate material along a processing path in a first direction; and an adhesive applicator positioned along the processing path; the adhesive applicator comprising a nozzle configured to apply an adhesive material to a surface of the roofing substrate material; a drive system linked to the nozzle and configured to move the nozzle in a second direction as the roofing substrate material is moved the first direction; wherein movement of the nozzle in the second direction, movement of the roofing substrate material in the first direction, or a combination thereof, is controlled to apply a selected pattern of the adhesive material to the surface if the roofing substrate material; wherein the selected pattern of the adhesive material comprises at least one area having a first thickness or density of the adhesive material and at least one area having a second thickness or density of the adhesive material.

In embodiments, the drive system can comprise an eccentric bearing coupled to the nozzle in engagement with a drive gear, and a motor configured to rotate the drive gear, and wherein as the motor rotates the drive gear, the eccentric gear is rotated so as to cause the nozzle to move in an eccentric motion back and forth in the second direction across the surface of the roofing substrate material as the roofing substrate material is moved in the first direction.

In some embodiments, the drive system can comprise a support having a first end portion along which the nozzle is mounted and a second end portion linked to a crank; and a motor configured to drive rotation of the crank; wherein the crank is configured to move the support in a substantially linear motion so as to move the nozzle back and forth across the surface of the roofing substrate material.

In embodiments, the adhesive material comprises a self-seal adhesive applied as a fiberized spray.

In some embodiments, the adhesive material comprises an asphalt adhesive.

Another aspect of the disclosure includes, without limitation, a method comprising: conveying a roofing substrate material along a processing path in a first direction; applying a pattern of a fiberized adhesive to at least one surface of the roofing substrate material with an adhesive applicator; wherein, in embodiments, the adhesive applicator comprises a nozzle positioned along the processing path and configured to apply the pattern of fiberized adhesive to the roofing substrate material; and a drive system coupled to the nozzle and configured to move the nozzle in a second direction across the processing path; wherein applying the pattern of fiberized adhesive to the surface of the roofing substrate material comprises moving the nozzle in the second direction and depositing at least a first thickness or density of the fiberized adhesive at a first position on the surface of the roofing substrate material, and depositing a second thickness or density of the fiberized adhesive at a second position on the surface of the roofing substrate material.

In embodiments, applying the pattern of fiberized adhesive further comprises spraying a self-seal adhesive material on the surface of the roofing substrate material.

In embodiments, moving the nozzle in a second direction can further comprise rotating the nozzle in a helical or substantially circular motion; and wherein depositing at least the first thickness or density of the fiberized adhesive at the first position and depositing the second thickness or density of the fiberized adhesive at the second position can comprise intermittently spraying of the fiberized adhesive onto the surface of the roofing substrate material.

In embodiments, applying the pattern of the fiberized adhesive to the surface of the roofing substrate material can further comprise dispersing a substantially circular of helical pattern of the fiberized adhesive onto the surface of the roofing substrate material along a common bond area corresponding to a nail zone of a finished roofing shingle.

In addition, in embodiments, the fiberized adhesive can comprise a self-seal adhesive adapted to substantially seal about a nail head of one or more fasteners received through the nail zone of the finished roofing shingle.

According to still another aspect of the present disclosure, a roofing shingle is provided. In embodiments, the roofing shingle can comprise a first layer comprising a headlap portion; an exposure portion; and a nail zone defined between the headlap portion and the exposure portion; a second layer positioned beneath the first layer; and an adhesive material applied to at least one of the first layer and the second layer, wherein the adhesive material is applied in a pattern along a common bond area between the first and second layers, the adhesive material adapted to attach the first and second layers together along the common bond area; wherein the pattern includes at least a first thickness or density of the adhesive material at a first position along the common bond area, and a second thickness or density of the adhesive material at a second position along the common bond area.

In embodiments, the adhesive material can comprise a fiberized adhesive.

In embodiments, the common bond area is positioned substantially in alignment with the nail zone of a finished roofing shingle; and in some embodiments, the adhesive material can comprise a self-seal adhesive configured to adhere the second layer to the first layer and substantially seal about a fastener received through the nail zone.

According to another aspect, a roof structure comprises roof deck; and a plurality of roofing shingles positioned along the roof deck; wherein each of the roofing shingles comprises a roofing shingle, comprising: a first layer comprising a headlap portion; an exposure portion; and a nail zone defined between the headlap portion and the exposure portion; a second layer positioned beneath the first layer; and a fiberized adhesive applied between the first layer and the second layer; wherein the fiberized adhesive is applied along a common bond area and is applied in a pattern having at least a first thickness or density of the fiberized adhesive at a first position along the common bond area, and a second thickness or density of the fiberized adhesive at a second position along the common bond area; and wherein the fiberized adhesive is configured to adhere the second layer to the first layer.

In embodiments, the common bond area is positioned substantially in alignment with the nail zone of the roofing shingle; and wherein the fiberized adhesive comprises a self-seal adhesive adapted to substantially seal about a nail head or shank of a fastener received through the nail zone of the roofing shingle.

Accordingly, various aspects and embodiments of roofing shingles and systems and methods of forming roofing shingles are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced.

FIG. 1A is a top plan view of an example embodiment of a roofing shingle according to principles of the present disclosure.

FIG. 1B is a bottom plan view of the roofing shingle of FIG. 1A.

FIG. 1C is a perspective view illustrating the layers of a roofing shingle such as shown in FIGS. 1A-1B.

FIG. 2 is a top plan view schematically illustrating an example embodiment of a system and method for forming roofing shingles having a fiberized adhesive pattern applied to a second layer or backer according to principles of the present disclosure.

FIG. 3A is a top plan view schematically illustrating an example embodiment of a system and method for applying a fiberized adhesive to a roofing substrate material according to principles of the present disclosure.

FIG. 3B is an end view schematically illustrating the adhesive applicator of the system of FIG. 3A.

FIG. 4 schematically illustrates an additional example embodiment of a system and method for applying a fiberized adhesive to a roofing substrate material according to principles of the present disclosure.

FIG. 5 illustrates an example embodiment a roofing structure for a roof, including a plurality of roofing shingles such as shown in FIGS. 1A-1C, according to principles of the present disclosure.

### DETAILED DESCRIPTION

Embodiments of roofing shingles 100 having applications of adhesive materials, including application of a fiberized adhesive to a roofing substrate material 10 in selected patterns along a common bond area between layers of the roofing material substrate, and which, in embodiments, generally corresponds to a nail zone of a resultant formed roofing shingles, and systems and methods for forming roofing shingles, including the application of adhesive materials between the layers of roofing substrate materials for attachment of the layers together to form roofing shingles, according to principles of the present disclosure will now be described in more detail with reference to the attached drawing figures.

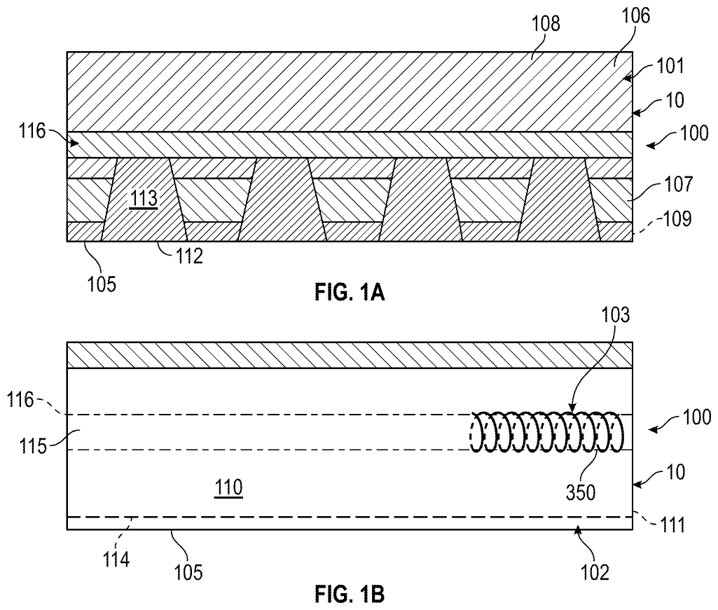

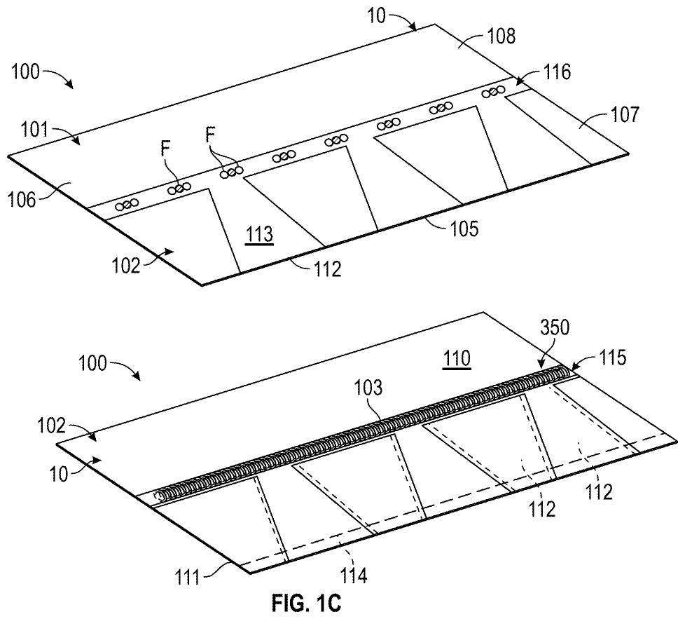

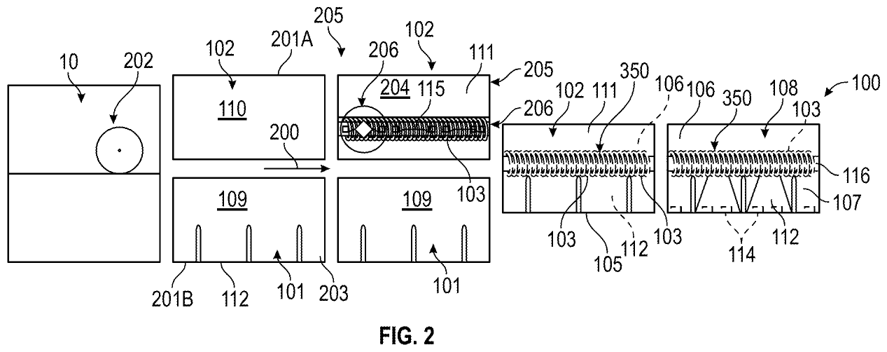

In embodiments, such as schematically illustrated in FIGS. 1A-4, the roofing shingles 100 can be comprised of a roofing substrate material 10, and in some embodiments, can be formed as laminated roofing shingles 100, having a plurality of layers of roofing shingle materials. For example, in embodiments, as shown in FIGS. 1C-2, each roofing shingle 100 can include a first layer 101 and a second layer 102 formed from a roofing shingle material 10, which, in some non-limiting example embodiments, can include fiberglass or polymer web materials coated with asphalt.

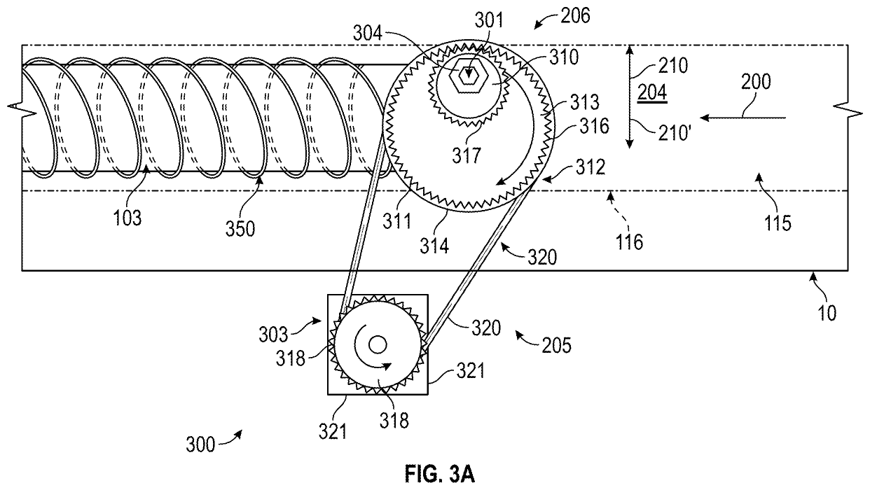

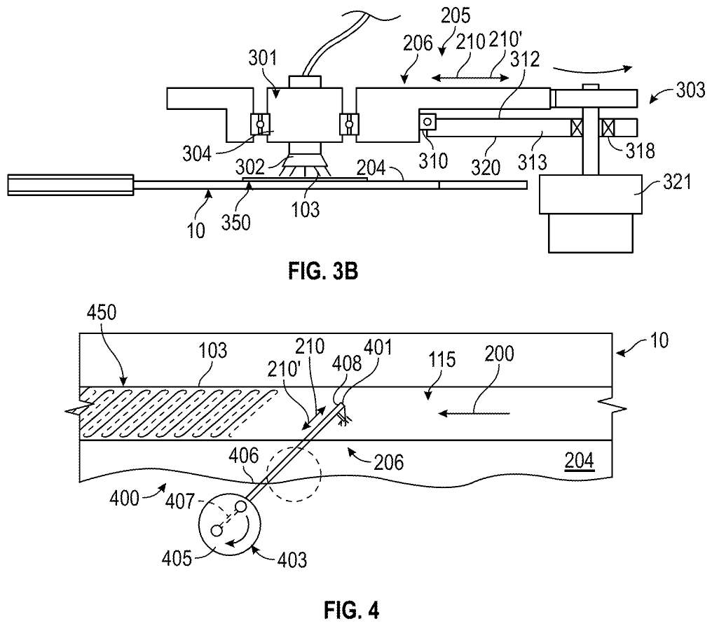

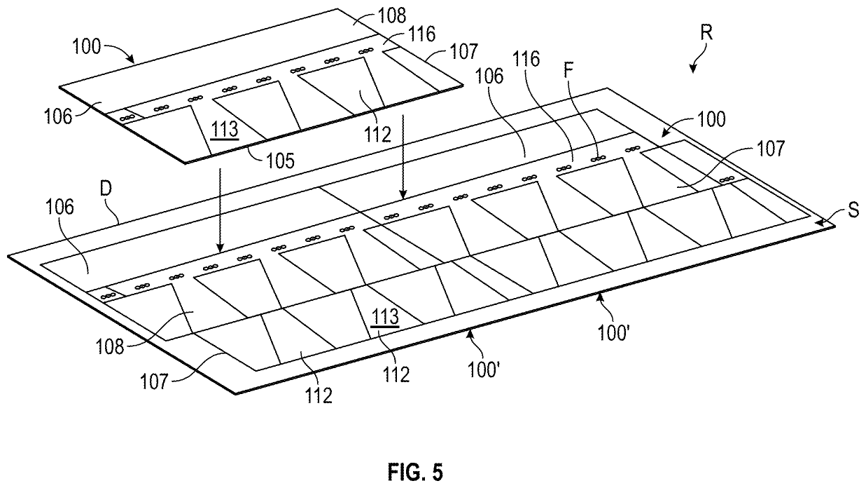

In embodiments, the first and second layers 101/102 can be attached together by an adhesive material applied to at least one of the first and second layers in a selected pattern. By way of example and not limitation, in embodiments, the adhesive material can include self-seal adhesive material applied as a fiberized adhesive 103. In embodiments the fiberized adhesive 103 can be applied in an intermittent pattern that can be applied over an expanded or wider area across a surface of the roofing substrate material 10, such as indicated in FIGS. 3A and 4 without requiring an increase in the amount of the fiberized adhesive applied to obtain such coverage. Alternatively, or in addition, in some embodiments, the adhesive material can be applied as a fiberized adhesive that can be applied in varying thicknesses or densities to at least one of the first and second layers of the roofing shingles, and along selected areas or portions thereof, during a process for formation of the roofing shingles 100, such as indicated in FIGS. 2-4.

As used herein, the term “fiberized adhesive” can include a variety of adhesive materials that can be applied to attach layers of roofing substrate material in accordance with the principles of the present disclosure, including applications of one or more adhesive materials as a fiberized adhesive spray or similar application.

In some non-limiting embodiments, such as illustrated in FIGS. 1A and 1C, the first layer 101 of each roofing shingle 100 can comprise a headlap portion 106 and an exposure portion 107 that are defined along an upper surface or top facing portion 108 of each roofing shingle 100. In addition, the first layer 101 further will include a rear or bottom facing surface 109 on an opposite side of the first layer from the upper surface 108. As illustrated in FIG. 5, in embodiments, the exposure portion 107 of each roofing shingle can extend from the headlap portion 106 to a front edge 105 of the roofing shingle 100, and will be configured to overlap the headlap portion of an adjacent roofing shingle. For example, as shown in FIG. 5, the exposure portions 107 of roofing shingles 100 in a higher course of roofing shingles can overlap the headlap portions 106 of adjacent roofing shingles 100′ arranged in a lower course of roofing shingles along a roof deck D for forming a roof structure S of a roof R. In embodiments, the exposure portion of each roofing shingle will define a visible portion of the roofing shingle along the roof.

As indicated in FIGS. 1B-1C, the second layer 102 (also referred to as a backer) includes a front surface or portion 110 and a bottom surface or portion 111 (FIG. 1B). In addition, in some non-limiting embodiments, such as shown in FIG. 1A, the exposure portion 107 can have a plurality of tabs or teeth 112 each having a front surface 113; and in some embodiments, as shown in FIG. 1B, each roofing shingle 100 additionally can include a plurality of strips, beads, lines, dots or combinations thereof, of a sealant material 114 along the bottom surface 111 of the second layer 102, adjacent to the front edge 105 of the roofing shingle 100. In embodiments, the sealant material 114 can comprise a self-seal adhesive material configured to adhere the roofing shingle 100 of the upper course of roofing shingles to one or more adjacent shingles 100′ of the lower course of roofing shingles, with the exposure portion 107 of the roofing shingle 100 of the upper course of roofing shingles overlapping the headlap portion(s) 106 of the one or more adjacent shingles 100′ of the lower course of roofing shingles as indicated in FIG. 5.

In embodiments, the second layer 102 is attached to at least a portion of the first layer 102 via application of the fiberized adhesive 103 to form each roofing shingle 100. In embodiments, the fiberized adhesive 103 can be applied as a spray of fiberized adhesive, and can form an adhesive strip configured to attach the first and second layers 101/102 together. For example, in some embodiments, the fiberized adhesive can be applied as a plurality of beads, dashes or dots of adhesive, with such adhesive strips, beads, dashes or dots forming with selected pattern, e.g. a swirl or a substantially helical, curved or circular pattern as shown in FIG. 3A. In some embodiments, the fiberized adhesive 103 can be applied along a portion 204 of the front surface 110 of the second layer 102 corresponding to a common bond area 115 between the first and second layers of each roofing shingle. In other embodiments, the fiberized adhesive can be applied along a portion of the bottom surface of the first layer along an area corresponding to the common bond area 115.

As used herein, the term “common bond area” defines an area, indicated at 115 in FIGS. 1B-2, along at which the first and second layers are attached together across the length of the roofing shingle. The common bond area can include a portion of the roofing shingle 100 opposite a lower edge or portion of the headlap portion 106 (FIG. 1A) of the first layer 101 that is adjacent to a region where the exposure portion 107 overlies a portion of the second layer 102. As illustrated, for example, in FIGS. 1C and 2, the second layer 102 can be attached to the first layer 101 substantially along a central portion of each of the layers by the fiberized adhesive. In addition, as used herein, the term “in registration with” means “in alignment along” or “in line with”.

This common bond area further can be in registration with a “nail zone” 116 (FIG. 1A) defined along the top facing portion 108 of the first layer of each roofing shingle, as shown in FIG. 1A. The “nail zone” 116 defines a nailing area along the roofing shingle where fasteners F are to be inserted to secure the roofing shingle to the roof deck D (e.g., as shown in FIG. 5). In embodiments, the nail zone can be positioned along an area defined between the exposure portion 107 and headlap portion 106 of the first layer 101, above the plurality of tabs 112 of the exposure portion of each roofing shingle.

In embodiments, the common bond area can have a width of 0.25 inches to 3 inches wide, and in embodiments, a width of 0.25 inches to 2.75 inches wide; 0.25 inches to 2.5 inches wide; 0.25 inches to 2.25 inches wide; 0.25 inches to 2 inches wide; 0.25 inches to 1.75 inches wide; 0.25 inches to 1.5 inches wide; 0.25 inches to 1.25 inches wide; 0.25 inches to 1 inches wide; 0.25 inches to 0.875 inches wide; 0.25 inches to 0.75 inches wide; 0.25 inches to 0.5 inches wide; 0.25 inches to 0.375 inches wide; 0.375 inches to 3 inches wide; 0.375 inches to 2.75 inches wide; 0.375 inches to 2.5 inches wide; 0.375 inches to 2.25 inches wide; 0.375 inches to 2 inches wide; 0.375 inches to 1.75 inches wide; 0.375 inches to 1.5 inches wide; 0.375 inches to 1.25 inches wide; 0.375 inches to 1 inch wide; 0.375 inches to 0.875 inches wide; 0.375 inches to 0.75 inches wide; 0.375 inches to 0.5 inches wide; 0.5 inches to 3 inches wide; 0.5 inches to 2.75 inches wide; 0.5 inches to 2.5 inches wide; 0.5 inches to 2 inches wide; 0.5 inches to 1.75 inches wide; 0.5 inches to 1.5 inches wide; 0.5 inches to 1.25 inches wide; 0.5 inches to 1 inch wide, 0.5 inches to 0.875 inches wide; 0.5 inches to 0.75 inches wide; 0.75 inches to 3 inches wide; 0.75 inches to 2.75 inches wide; 0.75 inches to 2.5 inches wide; 0.75 inches to 2.25 inches wide; 0.75 inches to 2 inches wide; 0.75 inches to 1.75 inches wide; 0.75 inches to 1.5 inches wide; 0.75 inches to 1.25 inches wide; 0.75 inches to 1 inch wide; or 0.75 inches to 0.875 inches wide; 0.875 inches to 3 inches wide; 0.875 inches to 2.75 inches wide; 0.875 inches to 2.5 inches wide; 0.875 inches to 2.25 inches wide; 0.875 inches to 2 inches wide; 0.875 inches to 1.75 inches wide; 0.875 inches to 1.5 inches wide; 0.875 inches to 1.25 inches wide; 0.875 inches to 1 inch wide; 1 inch to 3 inches wide; 1 inch to 2.75 inches wide; 1 inch to 2.5 inches wide; 1 inch to 2.25 inches wide; 1 inch to 2 inches wide; 1 inch to 1.75 inches wide; 1 inch to 1.5 inches wide; 1 inch to 1.25 inches wide; 1.25 inches to 3 inches wide; 1.25 inches to 2.75 inches wide; 1.25 inches to 2.5 inches wide; 1.25 inches to 2.25 inches wide; 1.25 inches to 2 inches wide; 1.25 inches to 1.75 inches wide; 1.25 inches to 1.5 inches wide; 1.5 inches to 3 inches wide; 1.5 inches to 2.75 inches wide; 1.5 inches to 2.5 inches wide; 1.5 inches to 2.25 inches wide; 1.5 inches to 2 inches wide; 1.5 inches to 1.75 inches wide; 1.75 inches to 3 inches wide; 1.75 inches to 2.75 inches wide; 1.75 inches to 2.5 inches wide; 1.75 inches to 2.25 inches wide; 1.75 inches to 2 inches: 2 inches to 3 inches wide; 2 inches to 2.75 inches wide; 2 inches to 2.5 inches wide; 2 inches to 2.25 inches wide; 2.25 inches to 3 inches wide; 2.25 inches to 2.75 inches wide; 2.25 inches to 2.5 inches wide; 2.5 inches to 3 inches wide; 2.5 inches to 2.75 inches wide; and 2.75 inches to 3 inches wide. Other widths also can be provided.

In embodiments, the nail zone can have a width that substantially corresponds to a width of the common bond. In other embodiments, the nail zone can have a width that is less that the width of the common bond area, with the common bond area overlapping the nail zone on one or both of its upper and lower edges. For example, in embodiments, the nail zone can have a width of 0.10 inches to 3 inches; and in some embodiments, can have a width of 0.10 inches to 2.5 inches wide; 0.10 inches to 2.25 inches wide; 0.10 inches to 2 inches wide; 0.10 inches to 1.75 inches wide; 0.10 inches to 1.5 inches wide; 0.10 inches to 1.25 inches wide; 0.10 inches to 1 inches wide; 0.10 inches to 0.875 inches wide; 0.10 inches to 0.75 inches wide; 0.10 inches to 0.5 inches wide; 0.10 inches to 0.375 inches wide; 0.375 inches to 2.5 inches wide; 0.375 inches to 2.25 inches wide; 0.375 inches to 2 inches wide; 0.375 inches to 1.75 inches wide; 0.375 inches to 1.5 inches wide; 0.375 inches to 1.25 inches wide; 0.375 inches to 1 inch wide; 0.375 inches to 0.875 inches wide; 0.375 inches to 0.75 inches wide; 0.375 inches to 0.5 inches wide; 0.5 inches to 2.5 inches wide; 0.5 inches to 2 inches wide; 0.5 inches to 1.75 inches wide; 0.5 inches to 1.5 inches wide; 0.5 inches to 1.25 inches wide; 0.5 inches to 1 inch wide, 0.5 inches to 0.875 inches wide; 0.5 inches to 0.75 inches wide; 0.75 inches to 2.5 inches wide; 0.75 inches to 2.25 inches wide; 0.75 inches to 2 inches wide; 0.75 inches to 1.75 inches wide; 0.75 inches to 1.5 inches wide; 0.75 inches to 1.25 inches wide; 0.75 inches to 1 inch wide; or 0.75 inches to 0.875 inches wide; 0.875 inches to 2.5 inches wide; 0.875 inches to 2.25 inches wide; 0.875 inches to 2 inches wide; 0.875 inches to 1.75 inches wide; 0.875 inches to 1.5 inches wide; 0.875 inches to 1.25 inches wide; 0.875 inches to 1 inch wide; 1 inch to 2.5 inches wide; 1 inch to 2.25 inches wide; 1 inch to 2 inches wide; 1 inch to 1.75 inches wide; 1 inch to 1.5 inches wide; 1 inch to 1.25 inches wide; 1.25 inches to 2.5 inches wide; 1.25 inches to 2.25 inches wide; 1.25 inches to 2 inches wide; 1.25 inches to 1.75 inches wide; 1.25 inches to 1.5 inches wide; 1.5 inches to 2.5 inches wide; L5 inches to 2.25 inches wide; 1.5 inches to 2 inches wide; 1.5 inches to 1.75 inches wide; 1.75 inches to 3 inches wide; 1.75 inches to 2.5 inches wide; 1.75 inches to 2.25 inches wide; 1.75 inches to 2 inches; 2 inches to 2.5 inches wide; 2 inches to 2.25 inches wide. Other widths are also can be used. In addition, as indicated in FIG. 1A, in some embodiments, the nail zone 116 further can be marked or otherwise identified along the top facing portion of the first layer, e.g. in embodiments, including with a fine stripe and/or one or more paint or print lines to indicate the nail zone.

FIG. 2 is a schematic illustration of an example embodiment of a process for forming the roofing shingles 100, in which a roofing substrate material 10 is moved along a processing path, indicated by arrow 200. In the illustrated embodiment, the roofing substrate material 10 can be passed through a first cutting station 202 at which the roofing substrate material can be separated into multiple lanes 201A and 201B. In embodiments, the first and second layers, 101 and 102 of roofing substrate material can be fed along the processing path 200, each being moved along a separate one of the lines 201A/201B, respectively, and can be combined to form the roofing shingle 100. Additionally, in some embodiments, the roofing substrate material of each of the first and second layers 101, 102 can be moved along a substantially continuous processing line as a substantially continuous web of roofing shingle material that can be brought together downstream where the first and second layers can be adhered together and thereafter passed through a cutting station where individual roofing shingles or sheets of multiple roofing shingles (e.g., three roofing shingles 100 as shown in FIG. 2) can be formed.

As illustrated in FIG. 2, in some embodiments, the roofing substrate material 10 can be cut longitudinally in the first cutting station to separate the layers 101/102 of roofing substrate material into respective lanes 201A/201B, and in embodiments, further can be cut width-wise to form separate sheets 203 of roofing shingle materials that can define the first and second layers 101/102 of the roofing shingle 100. Thereafter, in embodiments, the roofing substrate material moving along at least one lane 201A or 201B can have an adhesive material e.g. fiberized adhesive 103, applied along a surface 204 thereof. For example, in embodiments, the lane 201A along which a second layer 102 or backer of the roofing shingles is conveyed can pass through an adhesive station 205.

In embodiments, the adhesive station 205 includes an adhesive applicator 206 (FIGS. 3A-4) configured to apply the fiberized adhesive 103 to the surface 204 of the roofing substrate material as the roofing substrate material is moved in a first direction along its processing path 200 past the adhesive applicator. In embodiments, the fiberized adhesive 103 can be applied to the roofing shingle material along an area that can correspond to a common bond area 115 along which the layers of shingle material 101/102 will be attached to form a finished roofing shingle 100. In embodiments, the common bond area further can correspond to a nail zone of the finished roofing shingle.

In embodiments, the fiberized adhesive 103 can include various adhesive materials, for example, a contact adhesive, a pressure sensitive adhesive or other, similar self-seal adhesive that can be applied as a fiberized spray or application. For example, the fiberized adhesive can include asphalt adhesives, butyl adhesives, acrylic adhesives, epoxies, polyurethane adhesives, solvent-based adhesives, emulsion adhesives, and/or, other similar self-seal adhesive materials. In embodiments, the fiberized adhesive 103 can further comprise an adhesive material with re-sealing properties such that as fasteners (e.g., roofing nails, screws or other mechanical fasteners) are inserted along the nail zone of the roofing shingles, and through the first layer and second layer or backer thereof, the fiberized adhesive can be adopted to substantially self-reseal around the shank and/or head of the fastener.

As further indicated in FIG. 2, after application of the fiberized adhesive 103 to at least one of the first or second layers 101/102 of the roofing shingles, the first and second layers can be brought together, with the common bond area 115 and nail zone 116 of the roofing shingles generally being arranged substantially in registration with each other. In embodiments, as shown in FIGS. 1B and 5, a sealant material 114, such as a self-seal or pressure sensitive sealant material, further can be applied along the bottom surface 111 of the second layer 102, e.g., along the bottom surface of the second layer opposite the exposure portion 107 of the first layer 101. In embodiments, such as shown in FIG. 2, such a sealant material 114 can be applied as beads, dots, strips, or lines of a self-seal sealant material or pressure sensitive adhesive applied adjacent a lower edge of each roofing shingle opposite each of the teeth of the exposure portion. The sealant material can be configured so that exposure portions 107 of the roofing shingles can be adhered to and substantially sealed against the headlap portions 106 of adjacent roofing shingles of a lower course of roofing shingles such as indicated in FIG. 5.

FIGS. 3A-4 schematically illustrate example non-limiting embodiments of systems 300/400 and methods for the application of an adhesive material such as a fiberized adhesive 103 in varying selected patterns along the roofing substrate material 10 at locations substantially corresponding to the common bond area 115 between the first and second layers of each of the resultant formed roofing shingles. For example, in embodiments, the fiberized adhesive can be applied in a substantially circular or non-linear pattern, for example, an arcuate, helical, wave-like or swirled pattern such as illustrated at 350 in FIG. 3A. In other embodiments, the fiberized adhesive 103 can be applied in other patterns, such as, for example, straight, diagonally extending lines or other substantially linear patterns, such as indicated in FIG. 4. In embodiments, the fiberized adhesive can be sprayed, deposited or dispersed along the surface 204 of the roofing substrate material as one or more lines, dashes, beads, dots, strips or combination thereof, including being applied in substantially continuous and/or broken patterns thereof, such as shown in FIG. 4.

As indicated in FIGS. 3A-3B, in embodiments, the 103 adhesive material can be applied as a substantially continuous spray of fiberized adhesive 103 by the adhesive applicator, and can be applied in selected patterns across a surface of the roofing substrate material. For example, in some non-limiting embodiments, the fiberized adhesive 103 can be configured as an adhesive strip that can be located at and can extend along a common bond area 115, and can comprise an intermittent pattern of spaced lines, strips, dashes, dots, beads, or combinations thereof, with gaps defined therebetween that can be configured to enable drainage of water. In addition, in some embodiments, the fiberized adhesive can be applied as an adhesive strip configured to attach first and second layers of the roofing substrate material 10 together, and, in embodiments, can include a combination of solid lines, strips, lines, dots, beads, or combinations thereof having varying thicknesses of fiberized adhesive.

In some embodiments, other patterns, such as a flatter fiberized adhesive pattern, can be applied to the roofing substrate material 10, rather than a plurality of discrete dots or beads, and can be applied to the roofing substrate material along or across a wider area of the roofing substrate material, defining a common bond area 115 of increased width, while still enabling utilization of substantially the same amount of adhesive, or, in embodiments, less adhesive. Such a flatter wider fiberized adhesive pattern can be adjusted to create a stronger adhesive bond between the first and second layers by providing an increased or larger cross-section of adhesive along the common bond area of the roofing shingles, as opposed to a standard self-seal line or dot of adhesive. In some embodiments, the fiberized pattern also can comprise substantially flat layer of fiberized adhesive formed as a substantially rectangular strip, and, alternatively, or in addition, can comprise a plurality of dashes, lines, beads, dots, or combinations thereof, of fiberized adhesive applied across the surface of the roofing substrate material, with at least a portion of such dashes, lines, beads, dots, or combinations thereof. For example, in embodiments, such as indicated in FIGS. 3A and 4, the fiberized adhesive 103 can be applied in a pattern of one or more unbroken lines, e.g. substantially straight lines or substantially accurate or curved lines, with an additional line or lines, dashes, beads, dots, or a combination thereof, in proximity therewith.

In embodiments, the selected patterns of the fiberized adhesive applied to the roofing substrate material will be configured help conserve or reduce an amount of adhesive material required to attach the first and second layers without reducing strength of the adhesive bond therebetween. For example, in some embodiments, the selected patterns can include depositing varying thicknesses or densities of the fiberized adhesive applied, and in embodiments, different thicknesses or densities of the fiberized adhesive can be applied at different locations, e.g., at least a first thickness or density can be applied to the roofing substrate material at a first position along the surface of the roofing substrate material, and a second thickness or density of the fiberized adhesive can be applied at a second position along the surface of the roofing substrate material. In addition, in embodiments, the selected patterns can included gaps or spaces, which also can help conserve or reduce an amount of adhesive material required to attach the first and second layers.

In addition, as the roofing shingles are attached to the roof deck by fasteners F, such as shown FIG. 5, the fiberized adhesive can be adapted to substantially surround the fasteners inserted through the nail zone, further locking the second layer or backer to the first layer, as well as substantially capturing the fasteners; including, in some embodiments, capturing and sealing about the heads and/or shanks of the fasteners, which also can help substantially limit movement of the fasteners after application. As noted above, the fiberized adhesive can include an adhesive having self-resealing properties that enable it to surround the fasteners and reseal about the fasteners as they are inserted therethrough to help seal openings in the roofing shingles formed by the fasteners F.

FIGS. 3A-3B illustrates a first embodiment 300 of a system for applying the fiberized adhesive 103 to the roofing substrate material 10 as the roofing substrate material 10 is moved in a first direction along its processing path 200 and through the adhesive station 205 as indicated FIG. 2. As illustrated in FIGS. 3A-3B, in an embodiment, the adhesive station 205 will include an adhesive applicator 206 including a nozzle 301 and a drive system 303 coupled to the nozzle and configured to drive the nozzle in a reciprocating path of travel along a second direction 210/210′ back and forth across the surface of the roofing substrate material as illustrated in FIGS. 3A-3B.

In an embodiment, as indicated in FIG. 3B, the nozzle 301 can include a spray nozzle having one or more spray tips or openings 302 configured to apply a substantially continuous spray of the fiberized adhesive 103 against a surface 204 of the roofing substrate material 10. In other embodiments, other types of nozzles can be used. The nozzle 301 can be mounted and carried by a carriage 304 coupled to the eccentric bearing and configured to support the nozzle as it is moved in a second direction of along travel across the surface of the roofing substrate material. As further illustrated in FIG. 3A, in embodiments, the drive system 303 can be configured for driving or moving the nozzle in the second direction across the surface of the roofing substrate material as the roofing substrate material is moved in the first direction along its processing path beneath the nozzle.

In the present embodiment, as shown in FIG. 3A, the drive system 303 is illustrated as including an eccentric drive mechanism that can include an eccentric bearing or gear 310 configured to engage and be driven by a larger, first drive gear 312. For example, in embodiments, the eccentric bearing can be received within and engage an inner circumference or race of the larger first drive gear 312. For example, as illustrated in FIG. 3A, the first drive gear 312 can include a body 313 having recess 314 defined therein, with a series of gear teeth 316 arranged along an inner sidewall 311 of the recess 314. In embodiments, the eccentric bearing can have a diameter less than the diameter of the larger first drive gear 312, and can include a series of teeth 317 arranged about its circumference 315 and configured to engage the teeth 316 formed along the sidewall 311 of the recess 314 of the first drive gear 312.

As indicated in FIG. 3A, a drive belt or chain 320 further can be extended about the first drive gear 312 and about a smaller diameter second drive gear 318. In embodiments, the first drive gear 312 can be mounted along or adjacent to one side of the processing path of the roofing substrate material, with the smaller diameter second drive gear being spaced therefrom. In embodiments, the second drive gear 318 can comprise a drive gear that will be driven by a motor 321 (FIG. 3B), and which in turn drives rotation of the first drive gear 312. As the first drive gear 312 is rotated, the eccentric bearing 310 is rotated by its engagement with the first drive gear. As a result, in embodiments, the nozzle is caused to be moved in a substantially eccentric or arcuate motion in in the second direction back and forth across the surface of the roofing substrate material, as indicated at 210/210′ and along a substantially non-linear, circular or helical path.

In an embodiment, the motor 321 of the drive system can include a servo motor having an internal controller, or wherein can be linked to a control system, and can include programing for a cam motion configured to drive the rotation of the eccentric drive mechanism. For example, the motor can be operated at varying rates to vary the rotation of the eccentric bearing 310, and correspondingly vary movement of the nozzle in an eccentric motion in the second direction, e.g. for causing the nozzle to apply a substantially circular or helical pattern of the fiberized adhesive having different thicknesses or densities of the fiberized adhesive applied at different areas along the surface 204 of the roofing substrate material 10. For example, selected patterns 350 of swirls or arcs of the fiberized adhesive can be applied across the surface 204, including lines, dots, beads, strips, or combinations thereof, being spread apart at varying distances. In addition, such eccentric motion can cause the nozzle to move at different rates, which, in embodiments, can create an intermittent pattern of the fiberized adhesive as shown in FIG. 3A.

In other embodiments, operation of the adhesive applicator 206 can be controlled such that varying thicknesses or densities of the fiberized adhesive can be applied to the surface of the roofing substrate material at different points or locations. For example, the motor 321 can be controlled to control the movement of the nozzle across the surface of the roofing substrate material to change (e.g. speed up or slow down) such rotation so that the fiberized adhesive can be applied in a greater amount or with a greater thickness at areas adjacent the ends of the roofing shingles, e.g., at locations where the nozzle starts its movement in the second direction across the roofing substrate material, and when the nozzle reaches the end of its length of travel and is turned and begins its movement along a return path of travel back across the surface of the roofing substrate material in its eccentric motion as the roofing substrate material is passed therebelow.

In embodiments, such as indicated in FIGS. 3A and 4, gaps or spaces in the application of the fiberized adhesive further can be provided due to the eccentric movement of the nozzle back and forth across the surface of the roofing substrate material, as indicated by arrows 210/210′ based on an offset between the eccentric bearing and the first drive gear. For example, in embodiments, an offset between the eccentric bearing and the first drive gear can be ⅜ inch to 1.0 inch, and in other embodiments, can be ⅜ inch to ⅞ inch, ⅜ inch to ¾ inch, ⅜ inch to ⅝ inch, ⅜ inch to ½ inch, ½ inch to 1.0 inch, ½ inch to ⅞ inch, ½ inch to ¾ inch, ½ inch to ⅝ inch, ⅝ inch to 1.0 inch, ⅝ inch to ⅞ inch, ⅝ inch to ¾ inch, ¾ inch to 1.0 inch, ¾ inch to ⅞ inch, and ⅞ inch to 1.0 inch. Other offsets between the eccentric bearing and the first drive gear also can be provided.

In embodiments, the offset between the eccentric bearing and the first drive gear can be selected to create gaps defined in the pattern of the fiberized adhesive applied to the surface of the roofing substrate material; for example, due to the return movement of the nozzle in an opposite direction across the surface of the roofing substrate material, such as indicated in FIG. 3A. In some embodiments, the fiberized adhesive further can be applied in a substantially continuous spray through the nozzle, which can be moved at a first rate of movement in the second direction across the surface of the roofing substrate material, and as the nozzle reaches an end of the length or amount of travel across the roofing substrate material, and is moved along its return path in the opposite direction back across the surface of the roofing substrate material, it can be moved at a second rate of movement that is different from the first rate of movement due to this offset.

As a result, in embodiments, the systems and methods of the present disclosure may enable a reduction in amounts of the fiberized adhesive required to ensure a substantial bond between the first and second layers of the roofing shingles, e.g., a reduced amount of adhesive can be used without weakening the strength of the attachment between the layers of a laminated roofing shingle. In addition, in embodiments, the application of the fiberized adhesive can help substantially lock the fasteners inserted into the nail zone in place to help deter shifting of the roofing shingles after installation.

FIG. 4 illustrates an additional embodiment 400 of the adhesive station 205, including an adhesive applicator 206. In this embodiment, the adhesive applicator 206 can include a nozzle 401 configured to apply the fiberized adhesive 103 to the surface 204 of the roofing substrate material 10, and a drive system 402 connected to the nozzle and configured to move the nozzle in the second direction across the surface of the roofing substrate material, indicated by arrows 210/210′ as the roofing substrate material is moved in the first direction along its processing path 200, passing beneath the nozzle. In the embodiment illustrated in FIG. 4, the drive system can comprise a crank mechanism 403 having a gear or crank 405 positioned along one side of the processing path of the roofing substrate material, and a support 406 that can be coupled to the crank at a first end 407 and to the nozzle 401 at a second end 408 thereof.

In embodiments, the nozzle can comprise a spray nozzle; and in some embodiments can include a bead applicator nozzle, while in other embodiments, a spray nozzle or other applicator can be used. In embodiments, the crank can be rotated by a motor, such as a servo motor or other similar drive mechanism, and as the crank is rotated, it can impart an eccentric motion to the support, and in response, the support can be caused to move in a substantially linear direction as indicated by arrows 210/210′, which in turn causes the movement of the nozzle back and forth in the second direction across the surface of the roofing substrate material, such as indicated in FIG. 4. In embodiments, the nozzle can be configured to apply the fiberized adhesive in a selected pattern 450 of lines, dashes, dots, strips, beads, or combinations thereof, and which, in embodiments, further can be applied in a substantially straight configuration, or can be applied in a substantially circular or helical pattern.

In addition, in embodiments, due to the off-center connection of the first end of the support to the crank, the nozzle can be moved across the surface of the roofing substrate material at a first rate of movement, and as the nozzle is moved in a return motion back across the surface of the roofing substrate material, it can be moved at a second rate of movement, which can differ from the first rate of movement such that the nozzle can apply an intermittent pattern of adhesive. Further, in embodiments, the crank can be located at varying positions along a length of the support 406 to adjust a length of the travel of the nozzle across the roofing substrate material,

For example, as indicated in FIG. 4, a plurality of lines, dashes, dots, strips, beads, or combinations thereof, of the fiberized adhesive can be applied in a substantially diagonal pattern, with a first leg of the pattern having broken appearance with a plurality of gaps there between and a second leg portion that is substantially solid. Such a pattern can be repeated for a desired length along the surface of the roofing substrate material to define an adhesive pattern along a portion of the roofing substrate material that generally will correspond to a common bond area between first and second layers of subsequently formed roofing shingles.

As further indicated in FIG. 4, in some embodiments, the crank 405 can be positioned closer to the roofing substrate material, and so as to provide a shorter movement of the support, and thus the path of travel of the nozzle as needed or desired. The crank further can be formed with various diameters or sizes, for example, having a diameter of 3 inches to 10 inches, and in some embodiments, 3 inches to 9 inches, 3 inches to 8 inches, 3 inches to 7 inches, 3 inches to 6 inches, 3 inches to 5 inches, 3 inches to 4 inches, 4 inches to 10 inches, 4 inches to 9 inches, 4 inches to 8 inches, 4 inches to 7 inches, 4 inches to 6 inches, 4 inches to 5 inches, 5 inches to 10 inches, 5 inches to 9 inches, 5 inches to 8 inches, 5 inches to 7 inches, 5 inches to 6 inches, 6 inches to 10 inches, 6 inches to 9 inches, 6 inches to 8 inches, 6 inches to 7 inches, 7 inches to 10 inches, 7 inches to 9 inches, 7 inches to 8 inches, 8 inches to 10 inches, 8 inches to 9 inches, and 9 inches to 10 inches. Other diameters also can be used.

In further embodiments, the amount of fiberized adhesive material applied by the nozzle can be varied or controlled to form varying patterns or thicknesses of the fiberized adhesive material applied to the surface of the roofing substrate material. For example, the nozzle can be connected to a supply of the fiberized adhesive, which supply can be controlled so as to feed varying amounts of the fiberized adhesive to the nozzle as the nozzle is moved in the second direction is moved back and forth across the surface of the roofing substrate material moving therebelow to apply different thicknesses of the fiberized adhesive to the roofing substrate material.

In addition, in still other embodiments, the systems and methods of the present disclosure can be adapted to apply the selected pattern of the fiberized adhesive to the surface of the roofing substrate material can comprise depositing a plurality of lines, strips, beads, dots, or combinations thereof, of the fiberized adhesive along an area opposite an exposure portion of a finished roofing shingle adjacent a forward edge thereof. For example, in embodiments, the fiberized adhesive can include a sealant material adapted to attach and seal the bottom surface of each roofing shingle to a front surface of a roofing shingle of a lower course of roofing shingles along a roof deck; and can be applied by controlling movement of the nozzle across the roofing substrate material and a flow of the fiberized adhesive being applied by the nozzle to selectively apply dots, dashes, lines, strips, beads, or combinations thereof, of the fiberized adhesive at locations below the exposure portion of each roofing shingle, and adjacent the front edges thereof.

The present disclosure has been described herein in terms of examples that illustrate principles and aspects of the present disclosure. The skilled artisan will understand, however, that a wide gamut of additions, deletions, and modifications, both subtle and gross, may be made to the presented examples without departing from the spirit and scope of the present disclosure.

1. A method comprising:
conveying a roofing substrate material along a processing path in a first direction;
as the roofing substrate material is moved along the processing path in the first direction, moving the roofing substrate material past an adhesive applicator;
wherein the adhesive applicator comprises:
a nozzle configured to apply an adhesive material to a surface of the roofing substrate material; and
a drive system linked to the nozzle and configured to move the nozzle in a second direction with respect to the processing path;
moving the nozzle in the second direction across the surface of roofing substrate material as the roofing substrate material along the processing path in the first direction; and
applying the adhesive material to the surface of the roofing substrate material with the adhesive applicator;
wherein the adhesive material is applied across the surface of the roofing substrate material in a substantially helical or circular pattern.

2. The method of claim 1, wherein the drive system comprises an eccentric drive mechanism coupled to the nozzle; and wherein moving the nozzle in a second direction comprises rotating the nozzle in an eccentric motion back and forth across the surface of the roofing substrate material.

3. The method of claim 1, wherein moving the nozzle in the second direction across the roofing substrate material comprises moving the nozzle across the surface of the roofing substrate material along an initial path of travel at a first rate, and moving the nozzle along a return path of travel back across the surface of the roofing substrate material at a second rate; wherein the second rate is different from the first rate.

4. The method of claim 3, wherein applying the adhesive material to the surface of the roofing substrate material further comprises applying varying thicknesses or densities of the adhesive material at selected locations along the surface of the roofing substrate material.

5. The method of claim 1, wherein applying the adhesive material to the surface of the roofing substrate material further comprises dispersing a fiberized adhesive in an intermittent pattern of lines, dots, dashes, beads, or combinations thereof along the surface of the roofing substrate material.

6. The method of claim 1, wherein applying the adhesive material to the surface of the roofing substrate material further comprises intermittently spraying a fiberized adhesive along the surface of the roofing substrate material; and wherein the fiberized adhesive comprises a self-seal adhesive material.

7. The method of claim 6, wherein intermittently spraying the fiberized adhesive along the surface of the roofing substrate material comprises applying at least a first thickness or density of the fiberized adhesive at a first position along the surface of the roofing substrate material, and applying a second thickness or density of the fiberized adhesive at a second position along the surface of the roofing substrate material.

8. The method of claim 1, wherein the drive system comprises a support having a first end portion along which the nozzle is mounted and a second end portion linked to a crank, and a motor configured to drive rotation of the crank; and wherein moving the nozzle across the processing path comprises rotating the crank and moving the support in a substantially linear motion so as to move the nozzle in the second direction back and forth across the surface of the roofing substrate material.

9. The method of claim 1, wherein the roofing substrate material comprises a first layer and a second layer; and wherein applying the adhesive material to the surface of the roofing substrate material comprises applying a fiberized spray of a self-seal adhesive to a surface of at least one of the first and second layers along an area corresponding to a common bond area between the first and second layers.

10. The method of claim 1, wherein applying adhesive material to the surface of the roofing substrate material comprises depositing at least a first thickness or density of a fiberized adhesive to the surface of the roofing substrate material, at a first position and depositing a second thickness or density of the fiberized adhesive to the surface of the roofing substrate material at a second position along an area corresponding to a nail zone of a finished roofing shingle.

11. The method of claim 1, wherein the adhesive material comprises a fiberized adhesive adapted to substantially seal about a nail head of one or more fasteners received through a nail zone of a finished roofing shingle.

12. A system, comprising:
a conveying system configured to move a roofing substrate material along a processing path in a first direction; and
an adhesive applicator positioned along the processing path, the adhesive applicator comprising:
a nozzle configured to apply an adhesive material to a surface of the roofing substrate material;
a drive system linked to the nozzle and configured to move the nozzle in a second direction across the surface of the roofing substrate material as the roofing substrate material is moved the first direction;
wherein movement of the nozzle in the second direction, movement of the roofing substrate material in the first direction, or a combination thereof, is controlled to apply the adhesive material to the surface of the roofing substrate material;
wherein the adhesive material is applied to the surface of the roofing substrate material in a substantially straight, helical or substantially circular pattern comprising at least one area having a first thickness or density of the adhesive material and at least one area having a second thickness or density of the adhesive material.

13. The system of claim 12, wherein the drive system comprises an eccentric bearing coupled to the nozzle in engagement with a drive gear, and a motor configured to rotate the drive gear, and wherein as the motor rotates the drive gear, the eccentric gear is rotated so as to cause the nozzle to move in an eccentric motion in the second direction across the surface of the roofing substrate material as the roofing substrate material is moved in the first direction.

14. The system of claim 12, wherein the drive system comprises a support having a first end portion along which the nozzle is mounted and a second end portion linked to a crank; and a motor configured to drive rotation of the crank; wherein the crank is configured to move the support in a substantially linear motion as the crank is rotated so as to move the nozzle back and forth across the roofing substrate material.

15. The system of claim 12, wherein the adhesive material comprises a self-seal adhesive, and the nozzle is configured to apply the self-seal adhesive as a fiberized spray.

16. A method comprising:
conveying a roofing substrate material along a processing path in a first direction;
applying a pattern of a fiberized adhesive to a surface of the roofing substrate material with an adhesive applicator;
wherein the adhesive applicator comprises:
a nozzle positioned along the processing path and configured to apply the pattern of fiberized adhesive to the roofing substrate material;
a drive system coupled to the nozzle and configured to move the nozzle in a second direction across the surface of the roofing substrate material;
wherein applying the pattern of the fiberized adhesive to the surface of the roofing substrate material comprises moving the nozzle in a second direction and depositing at least a first thickness or density of the fiberized adhesive at a first position along the surface of the roofing substrate material, and depositing a second thickness or density of the fiberized adhesive at a second position along the surface of the roofing substrate material.

17. The method of claim 16, wherein applying the pattern of fiberized adhesive further comprises spraying a fiberized self-seal adhesive material on to the surface of the roofing substrate material.

18. The method of claim 16, wherein moving the nozzle in a second direction further comprises rotating the nozzle in a helical or substantially circular motion; and wherein depositing at least the first thickness or density of the fiberized adhesive at the first position along the surface of the roofing substrate material, and depositing the second thickness or density of the fiberized adhesive at the second position along the surface of the roofing substrate material comprises intermittently spraying spray of the fiberized adhesive onto the surface of the roofing substrate material.

19. The method of claim 16, wherein applying the pattern of the fiberized adhesive to the surface of the roofing substrate material comprises applying the fiberized adhesive along an area corresponding to.

20. A roofing shingle, comprising:
a first layer comprising:
a headlap portion;
an exposure portion; and
a nail zone defined between the headlap portion and the exposure portion;
a second layer positioned beneath the first layer; and
a fiberized adhesive applied between the first layer and the second layer;
wherein the fiberized adhesive is applied along a common bond area and is applied in a pattern having at least a first thickness or density of the fiberized adhesive at a first position along the common bond area, and a second thickness or density of the fiberized adhesive at a second position along the common bond area;
wherein the fiberized adhesive comprises a self-seal adhesive configured to adhere the second layer to the first layer.

21. The roofing shingle of claim 20, wherein the common bond area is positioned substantially in alignment with a nail zone of a finished roofing shingle; and wherein the fiberized adhesive comprises a self-seal adhesive adapted to substantially seal about a nail head of one or more fasteners received through the nail zone of the finished roofing shingle.

22. A roof structure, comprising:
a roof deck; and
a plurality of roofing shingles positioned along the roof deck;
wherein each of the roofing shingles comprises: a first layer comprising:
a headlap portion;
an exposure portion; and
a nail zone defined between the headlap portion and the exposure portion; and
a second layer positioned beneath the first layer; and
a fiberized adhesive applied between the first layer and the second layer;
wherein the fiberized adhesive is applied along a common bond area and is applied in a pattern having at least a first thickness or density of the fiberized adhesive at a first position along the common bond area, and a second thickness or density of the fiberized adhesive at a second position along the common bond area;
wherein the fiberized adhesive comprises a self-seal adhesive configured to adhere the second layer to the first layer.

23. The roof structure of claim 22, wherein the common bond area is positioned substantially in alignment with the nail zone of the roofing shingle; and wherein the fiberized adhesive comprises a self-seal adhesive adapted to substantially seal about a nail head or shank of a fastener received through the nail zone of the roofing shingle.
